(19) United States
(12) Patent Application Publication
(10) Pub. No.: US 2013/0334789 A1
(43) Pub. Date: Dec. 19, 2013

(54) Bicycle Having Hammock-Style Seat

(71) Applicant: Brent E. Ingrim, Visalia, CA (US)

(72) Inventor: Brent E. Ingrim, Visalia, CA (US)

(21) Appl. No.: 13/969,603

(22) Filed: Aug. 18, 2013

Related U.S. Application Data
(63) Continuation-in-part of application No. 29/417,086, filed on Mar. 29, 2012, now Pat. No. D688165.

(51) Int. Cl. B62J 1/00

(52) U.S. Cl. CPC B62J 1/00
USPC 280/288.2; 280/281.1

(57) ABSTRACT

A bicycle having a hammock-style seat that is configured to allow the user to more comfortably ride the bicycle. The bicycle has front and rear wheel assemblies rotatably supported by a frame, handlebars attached at the forward end of the frame and a pedal crank mechanism. An upwardly disposed post supports a U-shaped rear seat support post having its ends directed toward the forward end of the frame. A front seat support post is attached to a frame member at the forward end of the frame. The hammock-style seat comprises a triangular-shaped support fabric having its base at the rear seat support post and its apex at the front seat support post to extend substantially the full length of the frame. An accessory post supports an umbrella or a board support apparatus, for supporting a surfboard or skateboard, generally above the seating area of seat.

### CROSS-REFERENCE TO RELATED APPLICATIONS

This patent application is a continuation-in-part of U.S. patent application Ser. No. 29/417,086 filed on Mar. 29, 2012, which issued as U.S. Pat. No. D688,165 on Aug. 20, 2013.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The present invention relates generally to bicycles. More specifically, the present invention relates to bicycles that have a frame which is configured for use with non-traditional seats and seating arrangements that support the user while he or she rides the bicycle. Even more particularly, the present invention relates to such bicycles in which the frame is also adapted to beneficially support one or more items that may be utilized with or without the bicycle, such as umbrellas, surfboards and skateboards.

B. Background

Bicycles are very likely the most common form of non-motorized transportation in the world. Many people ride bicycles for pleasure, as a means to exercise, for competition and/or as a means to get from one place to another. The conventional bicycle is a two-wheeled vehicle which is self-propelled by the rider of the bicycle. Although there are many types and brands of bicycles, they generally have the same basic components, namely a frame, pair of wheels that are rotatably supported by the frame, a set of handlebars toward the forward end of the frame, a seat generally supported towards the rearward end of the frame, a pedal-driven drive mechanism that is operated by the rider to propel the bicycle in a generally forward direction and a rider-operated braking system for stopping the bicycle. The conventional bicycle configuration provides for the rider to be seated on the seat generally perpendicular to the pedals with his or her hands reaching forward to grasp the handlebars to control the direction the bicycle moves. Most bicycles are configured for the user to lean a little or at least somewhat forward toward the handlebars. Other bicycles are configured with a different seat and cooperatively configured handlebar arrangement that allow the user to lean generally rearward when riding the bicycle.

A relatively recent configuration for the bicycle is commonly referred to as a recumbent bicycle. These bicycles are generally longer than conventional bicycles and are configured to position the rider lower to the ground, with the rider sitting slightly reclined in, most commonly, in a relatively high-backed seat. The longer wheelbase and lower center of gravity of the recumbent bicycle generally provides greater stability than the conventional bicycle. Many people consider the recumbent bicycle to allow for greater pedal efficiency and to provide more comfort than the conventional bicycle.

The typical seating arrangement for conventional bicycles positions the seat on top of an upwardly disposed post-like frame member of the bicycle frame. The standard bicycle seat is generally configured as a padded saddle that is configured to be straddled by the rider and support the rider's buttocks while he or she pedals the bicycle to operate the drive mechanism and propel the bicycle in the direction controlled by the position of the handlebars. This type of seating configuration has been around for many years and has been a general source of discomfort for the rider for likely nearly the entire existence of the bicycle. One of the problems with the current seating arrangement and seats is that the saddle configuration provides little surface area to comfortably support the buttocks of the rider. In addition, the typical bicycle seat is configured and padded such that the weight of the rider is generally concentrated on a relatively small portion of the buttocks while he or she is straddling the seat. An example of the typical bicycle seat is set forth in U.S. Pat. No. 2,395,346 to Schwinn. Despite the fact that over the years there have been many innovations with regard to the bicycle seat design, the typical bicycle seat is generally the same and supports the rider in generally the same manner as older-style bicycle seats. As a result, the typical modern bicycle seat has many of the same problems as older bicycle seats.

One configuration of a seating arrangement that is commonly utilized and well known for its comfort is the hammock. A typical hammock comprises a sheet of fabric, webbing or other material extended between two supporting posts that allows the material to slightly bow or curve downward so the user thereof can lay or sit comfortably on and be supported by the material. Despite the various comfort and support advantages of a hammock, they have not heretofore been adapted for use with bicycles. Several prior art patents describe bicycle seats as having a hammock or a hammock-like arrangement. One such patent is U.S. Pat. No. 5,597,202 to Andersen, which describes a slung fabric bicycle seat having a single piece of fabric that is slung across a frame member and, according to the inventor, resembling a hammock. The fabric is drawn taut and resides generally in a single plane to support the rider across a larger surface area. The seating arrangement of this bicycle seat, particularly how it attaches to the upright seat post of the frame, is generally the same as prior art seats. Another such patent is U.S. Pat. No. 4,176,880 to Marchello, which describes a bicycle seat having two padded seats covering the webbing that is slung between the upwardly disposed legs of a U-shaped seat frame. This seat also mounts to the frame in the same general manner as prior art seats, namely to the upright seat post of the frame. Yet another such patent is U.S. Pat. No. 5,887,882 to Atchison, which describes a prone bicycle having a generally centrally positioned sling that supports the torso of the rider as he lays along the frame of the bicycle. The sling only extends a relatively small portion of the length of the bicycle and is not configured for the rider to ride the bicycle in a sitting position.

One problem with conventional bicycles is that it is difficult to carry an umbrella while riding the bicycle. As can be readily appreciated by many bicycle riders, there are times when an umbrella can substantially enhance the riding experience of a bicycle. Besides being utilized in the rain to keep at least some of the water off of the rider, an umbrella can be utilized in hot weather to provide shade for the rider as he or she is riding the bicycle. Presently configured bicycles generally do not allow for use of an umbrella, unless the rider holds the umbrella in one of his or her hands, which prevents safety issues with regard to using only one hand on the handlebars to control the bicycle.

Another problem with conventional bicycles is that they are generally not configured to carry certain items, particularly elongated items, that the user may want to utilize at his or her destination, such as surfboards and skateboards. Although baskets and the like have been utilized with bicycles for many years, the typical bicycle-supported basket is not easily utilized or even adaptable to carry such items as a surfboard or a skateboard. Although some riders may be able to carry a skateboard in one hand or under one arm while riding a bicycle, this does have the problem of leaving only one hand available to control the bicycle, which could be dangerous in many situations. Generally, surfboards are not able to be carried at all by a bicycle rider while he or she is riding the bicycle.

Despite all of the improvements to bicycles and to bicycle seats in particular, what is needed is an improved bicycle that takes advantage of the properties of a hammock to provide the rider with a more comfortable seating arrangement. The improved bicycle should support a hammock-style seat that will distribute more of the rider's weight across the seat so he or she can more comfortably ride the bicycle. Preferably, the improved bicycle will be generally configured in a manner at least somewhat similar to conventional bicycles so that people familiar with bicycles will be able to easily ride the bicycle. The improved bicycle should also be adapted to more easily and safely carry items that can be utilized while riding the bicycle, such as an umbrella, and carrying items that can be used at the rider's destination, such as surfboards and skateboards.

### SUMMARY OF THE INVENTION

The bicycle having hammock-style seat of the present invention solves the problems and provides the benefits identified above. That is to say, the present invention discloses a new and improved bicycle that takes advantage of the various comfort and support properties of a hammock to provide the rider with a more comfortable seating arrangement while he or she is riding the bicycle. The hammock-style seat of the bicycle of the present invention distributes more of the rider's weight across the seat so he or she can more comfortably ride the bicycle. The bicycle of the present invention is configured generally similar to conventional bicycles, except for having a hammock-style seat and the frame being modified to support the hammock-style seat, such that people familiar with bicycles will be able to easily ride the new bicycle. The bicycle of the present invention is also configured to easily carry items that can be utilized while riding the bicycle, such as an umbrella, and carry items that can be used at the rider's destination, such as surfboards and skateboards, while allowing the rider to keep both of his or her hands on the bicycle handlebars.

In one general aspect of the present invention, the improved bicycle generally comprises a frame having a plurality of frame members defining a forward end and a rearward end of the frame, with one of the frame members defining an upwardly curved post having an upper end thereof at or near the rearward end of the frame, a front wheel assembly at the forward end of the frame, a rear wheel assembly at the rearward end of the frame, handlebars at the forward end of the frame, a pedal crank mechanism interconnecting the frame and the rear wheel assembly, a rear seat support post attached to or integral with the upwardly disposed end of the upwardly curved post, a front seat support post attached to one of the plurality of frame members at or near the forward end of the frame, and a hammock-style seat having a generally triangularly shaped support fabric with a base end connected to the rear seat support and an apex end connected to the front seat support post so as to extend said support fabric substantially between said forward end of said frame and said rearward end of said frame. The rear support post is generally U-shaped with a first end, a second end and a midsection disposed between the two ends. In a preferred embodiment, the rear seat support post is substantially horizontally disposed with each of the first end and the second end thereof being directed toward the forward end of the frame. The base end of the support fabric is supported by the midsection of the rear seat support substantially between the first and second ends thereof to form a seating area in the hammock-style seat.

In a preferred embodiment, a connecting mechanism interconnects the apex end of the support fabric and the front seat support post. In one embodiment, the support fabric comprises one or more tubular sections at the base end thereof, with the rear seat support post received in each of the tubular sections so as to dispose each of the tubular sections at the midsection of the rear seat support post and secure the base end of the support fabric to the rear seat support post. The bicycle can also include a positioning post that is attached to the rear seat support post and a positioning mechanism that interconnects the positioning post and the upper end of the upwardly disposed post to allow the rider to selectively position the rear seat support post and the base end of the support fabric relative to the upwardly disposed post. Preferably, the upper end of the upwardly disposed post has an opening sized and configured to receive the lower end of an accessory post that has an upper end that is attached to or integral with an umbrella or a board support apparatus so as to dispose either the umbrella or the board support apparatus generally above the seating area of the hammock-style seat. The umbrella can protect the rider from rain or shade him or her from the sun without the rider having to hold the umbrella as he or she steers the bicycle. The board support apparatus has a board member and a securing mechanism for securing a board item, such as a surfboard or a skateboard, to the board member so the item can be carried by the bicycle without the rider having to use one of his or her hands to hold it while riding the bicycle.

Accordingly, the primary aspect of the present invention is to provide a bicycle having a hammock-style seat that provides the advantages discussed above and which overcomes the disadvantages and limitations associated with presently available bicycles and bicycle seating arrangements.

It is an important object of the present invention to provide a new and improved bicycle that has a hammock-style seat which is configured to allow the rider of the bicycle to more comfortably ride the bicycle.

It is also an important aspect of the present invention to provide a bicycle that has a hammock-style seat which better distributes the rider's weight across the seat so he or she can more comfortably ride the bicycle.

It is also an important aspect of the present invention to provide a new and improved bicycle that has a hammock style seat which extends generally from the forward end to the rearward end of the bicycle frame, with the portion of the seat at the rearward end of the bicycle frame being supportedly extended across its width to provide a comfortable seating arrangement for the bicycle rider as he or she rides the bicycle.

It is also an important aspect of the present invention to provide a bicycle having a hammock-style seat that is configured generally similar to conventional bicycles, except for the hammock-style seat and the frame being modified to support the hammock-style seat, so people familiar with bicycles will be able to easily ride the new bicycle.

It is also an important object of the present invention to provide a new bicycle that has a hammock-style seat and which is configured to support an umbrella or other items that can be utilized while riding the bicycle and easily carry items that can be used at the rider's destination, such as surfboards and skateboards, in a manner that allows the rider to keep both of his or her hands on the bicycle handlebars.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a right side view of a bicycle having hammock-style seat configured according to a preferred embodiment of the present invention;

FIG. 2 is a left side view of the bicycle having hammock-style seat of FIG. 1;

FIG. 3 is a front view of the bicycle having hammock-style seat of FIG. 1;

FIG. 4 is a back view of the bicycle having hammock-style seat of FIG. 1;

FIG. 5 is a top plan view of the bicycle having hammock-style seat of FIG. 1;

FIG. 6 is a bottom plan view of the bicycle having hammock-style seat of FIG. 1;

FIG. 7 is an isolated view of the hammock-style seat of the bicycle of FIG. 1;

FIG. 8 is a right side view of the bicycle having hammock-style seat of FIG. 1 shown with an optional umbrella support apparatus extending upwardly from the rear seat support post with an umbrella supported thereon and extending forwardly therefrom;

FIG. 9 is a top plan view of the bicycle having hammock-style seat of FIG. 8; and

FIG. 10 is a right side view of the bicycle having hammock-style seat of FIG. 1 shown with an optional board support apparatus extending upwardly from the rear seat support post of the bicycle with a surfboard supported on the board support apparatus.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of preferred embodiments and only represent several possible ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and the description set forth herein are primarily directed to certain configurations for the various components of the new bicycle of the present invention and to exemplary materials for those components, persons skilled in the art will readily understand that this is merely for purposes of simplifying the present disclosure and that the present invention is not so limited. For instance, the frame and the hammock-style seat can be made out of a wide variety of different materials.

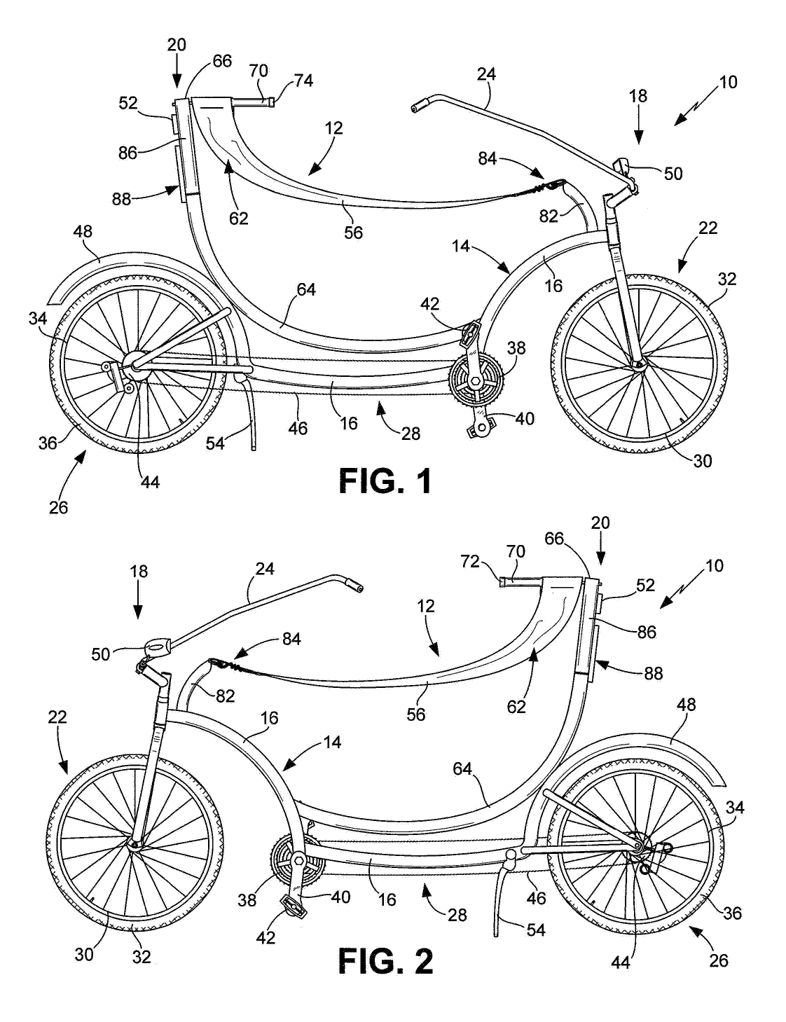

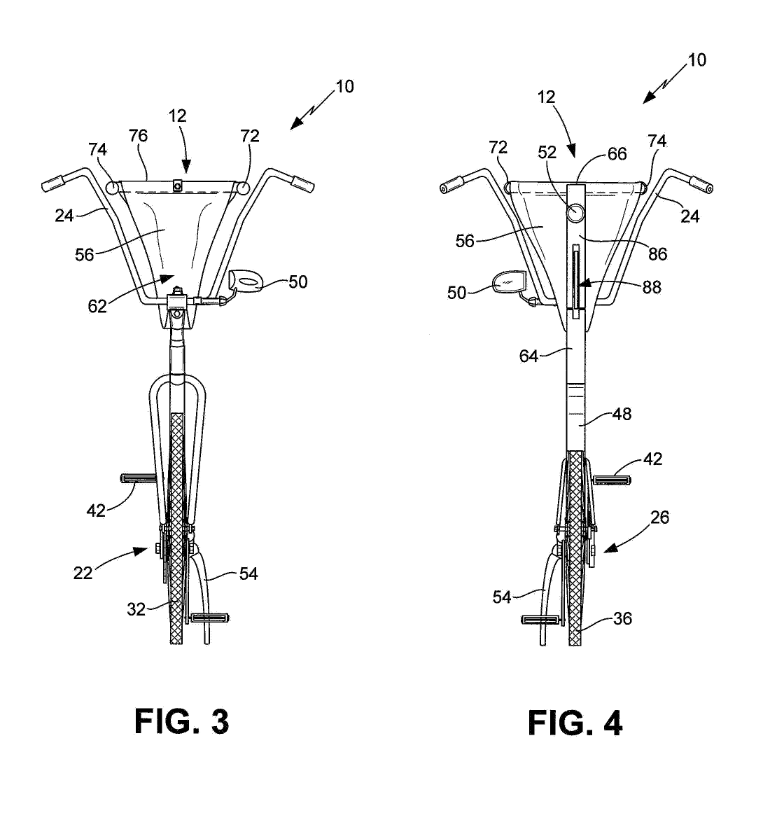

A bicycle that comprises the components and which is configured pursuant to various embodiments of the present invention is shown generally as 10 in the figures. Bicycle 10 has a hammock-style seat 12, described in detail below, that is configured to more comfortably support the rider as he or she is riding the bicycle 10. As with conventionally configured bicycles, the bicycle 10 of the present invention generally has a frame 14 with a plurality of frame members 16 that define a first or forward end 18 and a second or rearward end 20 of frame 14, a front wheel assembly 22 rotatably attached at or near the forward end 18 of the frame 14, handlebars 24 at or near the forward end 18 of frame 14 and a rear wheel assembly 26 rotatably attached at or near the rearward end 20 of the frame 14 and a pedal crank mechanism 28 operatively interconnecting the frame 14 to the rear wheel assembly 26, as best shown in FIGS. 1-4. As with conventional bicycles, the rider of bicycle 10 uses his or her feet and legs to operate the pedal crank mechanism 28 to provide power to the rear wheel assembly 26 and propel the bicycle 10 in a generally forward direction. The front wheel assembly 22 has a front wheel 30 supporting a tire 32 with a front wheel hub (not shown) rotatably attached to the frame 14 and the rear wheel assembly 26 has a rear wheel 34 supporting a tire 36 with a rear wheel hub (not shown) rotatably attached to frame 14, as best shown in FIGS. 1-4. The pedal crank mechanism 28 comprises one or more front sprockets 38 rotatably attached to the frame 14, a pair of pedal crank arms 40 attached to the front sprockets 38, pedals 42 at the outward ends of the pedal crank arms 40, a rearward gear assembly 44, having one or more sprockets (not shown), and a chain 46 that interconnects the front sprockets 38 and the rearward gear assembly 44, as best shown in FIGS. 1 and 2. As with conventional bicycles, bicycle 10 may include such optional equipment as fenders 48 (which in the embodiment shown in the figures is formed by one of the frame members 16), one or more forwardly directed lights 50, one or more rearwardly directed reflectors 52 and a kickstand 54, as best shown in FIGS. 1-4.

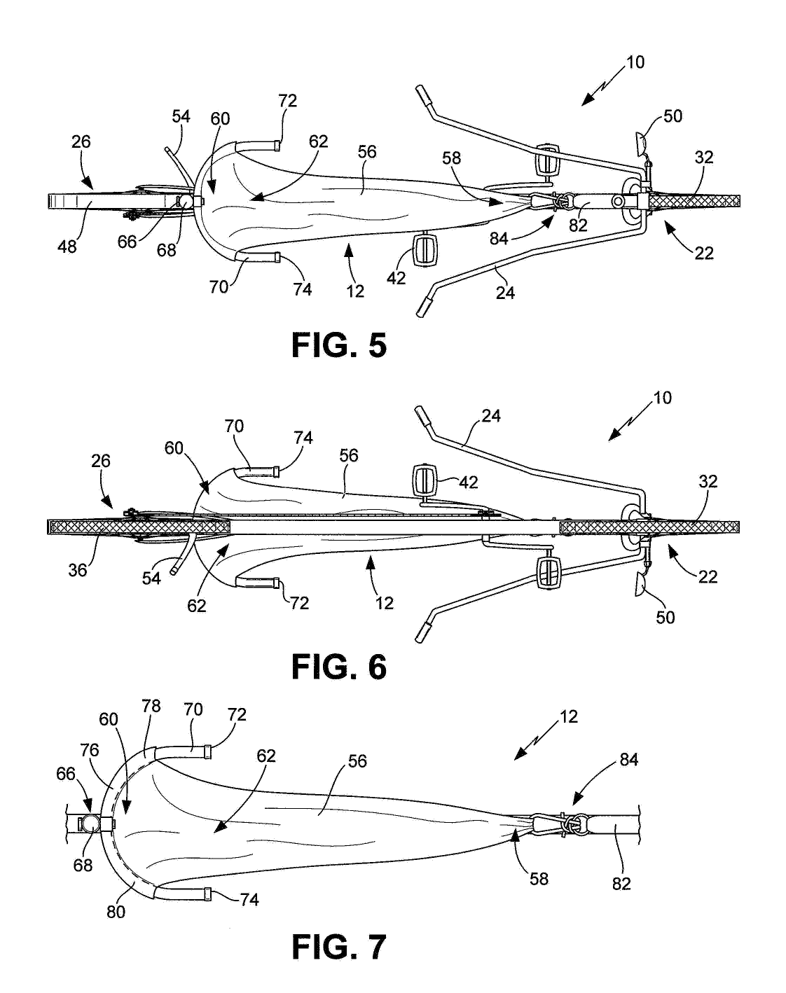

The hammock-style seat 12 of the present invention comprises a generally triangularly shaped support fabric 56 having first or apex end 58 and a second or base end 60, with the terms “apex” and “base” referring to how those terms are utilized to describe a triangle, namely that one side can be designated the base and the apex being the vertex of the triangle which is opposite the side which has been designated the base, as best shown in FIG. 7. As explained in more detail below, the apex end 58 is connected to the forward end 18 of the frame 14 and the base end 60 is connected toward the rearward end 20 of the frame, as best shown in FIGS. 1-2 and 5-6. When the support fabric 56 is connected, it forms a seating area 62 where the rider will sit when he or she rides the bicycle 10. In the preferred embodiment, the support fabric 56 is a single piece of material from the apex end 58 to the base end 60. The support fabric 56 can be made out of a wide variety of different materials, including cotton, nylon, canvas and the like or blends of materials. For instance, most materials which are utilized for hammocks will also work for the support fabric 56. The support fabric 56 can also comprise these materials formed in a webbing or other pattern having a plurality of openings. Generally, it is preferred that the material selected for support fabric 56 will be sufficiently comfortable, strong and flexible so that it will be comfortable against the rider, strong enough to support even larger size riders and flexible enough to substantially receive the rider into the seating area 62. Preferably, the material for support fabric should also be durable enough to withstand weather and temperatures which it is likely that the bicycle 10 will be exposed during the anticipated life of the hammock-style seat 12.

To support the hammock-style seat 12, the bicycle 10 of the present invention includes modifications to the frame 14 that are specially selected to mount the hammock-style seat 12 in a manner in which the rider of bicycle 10 will feel that he or she is in a hammock while riding bicycle 10. As will be readily appreciated by those persons familiar with hammocks, this type of seating will provide a much wider support area for the rider and, as a result, substantially lessen many of the issues with conventional bicycle seats with regard to the lack of comfort. The wider support area of the seating area 62 of the hammock-style seat 12 of the bicycle 10 of the present invention allows the rider to be much more comfortably supported than conventional bicycle seats. This type of comfort is not achieved by the “hammock” configurations of the prior art set forth above. In addition, it is believed that the modifications to the frame 14 presented herein also provide a more stylish and aesthetically appealing bicycle.

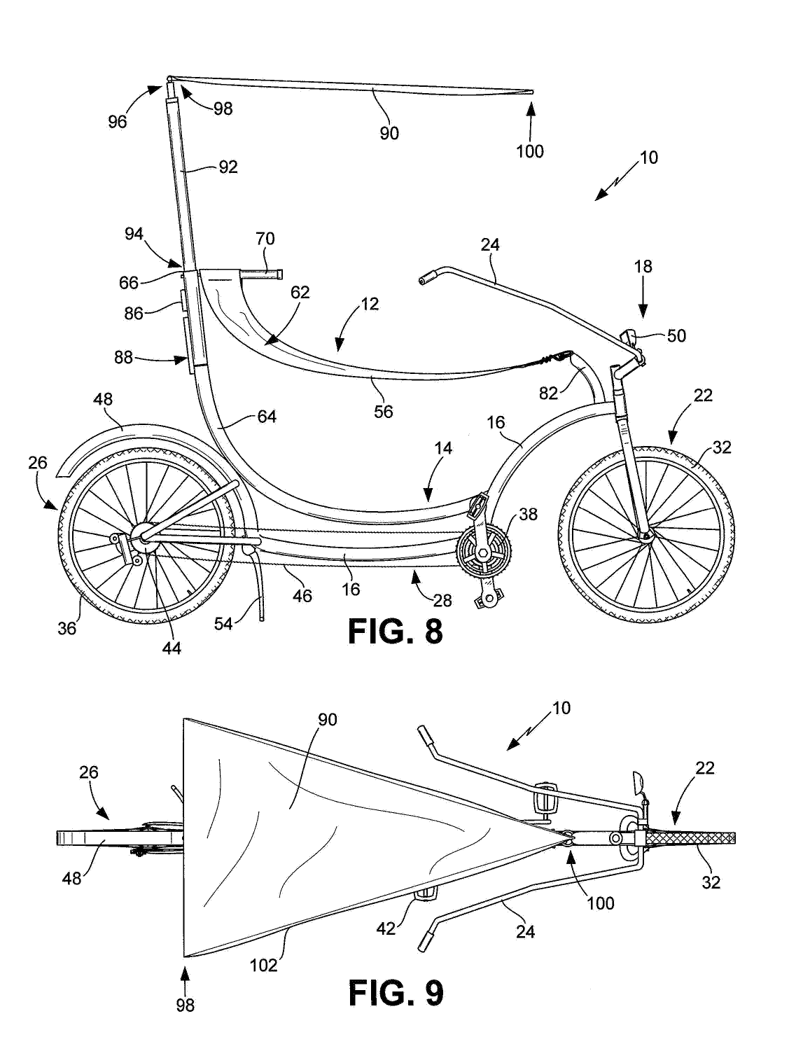

One such modification is the use of an upwardly curved post 64. In the present invention, the plurality of frame members 16 comprise the upwardly curved post 64 that substantially extends from the forward end 18 to the rearward end 20 of the frame 14, as best shown in FIGS. 1 and 2. As also shown in these figures, the upwardly curved post 64 has an upper end 66 at or near the rearward end 20 of frame 24. In a preferred embodiment, the upper end 66 of upwardly curved post 64 defines an opening 68, as best shown in FIG. 7, so bicycle 10 can carry one or more accessory items, as shown in FIGS. 8-10 and explained in more detail below. Attached to or integral with the upwardly curved post 64 is rear seat support post 70, which is sized and configured to attach to and support the base end 60 of the support fabric. In the preferred embodiment of the present invention, the rear seat support post 70 is generally U-shaped with a first end 72, second end 74 and a midsection 76 disposed between the first end 72 and second end 74, as best shown in FIGS. 1-3, 5 and 7. In one embodiment, the rear seat support post 70 is a tubular member having a round or substantially round cross-section that is made out of the same materials utilized for frame 14 and the rear seat support is substantially horizontally disposed (relative to the ground), as best shown in FIGS. 1 and 2. Preferably, the base 60 of the support fabric 56 removably attaches to the rear seat support post 70 so the support fabric 56 can be removed and cleaned as desired or changed out to provide a different color, pattern, material or the like variance that will provide a different look for bicycle 10 itself. In the embodiment shown in the figures, the base end 60 of the support fabric 56 comprises a first tubular section 78 that is sized and configured to slidably receive the first end 72 of the rear seat support post 70 therein and a second tubular section 80 that is sized and configured to slidably receive the second end 74 of the rear support post 70 therein so as to dispose both the first tubular section 78 and second tubular section 80 at the midsection 76 of the rear seat support post 70, as best shown in FIG. 7.

As shown in FIGS. 1-2, 5 and 7, the apex end 58 of the support fabric 56 attaches to the frame 14 at or near the forward end 18 thereof. In one embodiment, the support fabric 56 can fixedly or removably attach directly to one or more of the plurality of frame members 16. In the preferred embodiment, the apex end 58 of the support fabric 56 removably attaches to a front seat support post 82 attached to or integral with one of the frame members 16 generally at or near the forward end 18 of frame 14, as shown in FIGS. 1-2, 5 and 7. As shown in these figures, the apex end 58 connects to an aperture in the front seat support post 82 utilizing a connecting device 84, such as a string or cord that is tied, a clip member, a hook or a variety of other devices which can removably attach the apex end 58 to an aperture in the front seat support post 82. These devices are generally well known in the art. The connecting device 84 connects the apex end 58 of the support fabric 56 in a manner that allows the hammock-style seat 12 to freely swing relative to the forward end 18 of the frame 14.

In one embodiment, the upwardly curved post 64 is a single piece of tubular material that extends to where the rear seat support post 70 is connected thereto with the opening 68, when utilized, at the upper end 66 of the upwardly curved post 64. In the embodiment shown in the drawings, the upwardly curved post 64 includes a separate positioning post 86, the lower end of which is slidably received inside the upwardly curved post 64. The rear seat support post 70 is attached to or integral with the positioning post 86 such that the position of the rear seat support post (i.e., its height relative to the ground) is adjusted by moving the positioning post 86 up and down relative to the upwardly curved post 64 to allow riders of different heights to be able to easily get on/off bicycle 10 and ride bicycle 10. To allow such movement and to fix the position of the positioning post 86 relative to the upwardly curved post 64, and therefore the position of the rear seat support post 70 and the height of the seating area 62 relative to the ground, the bicycle 10 of the present invention utilizes a positioning mechanism 88 that interconnects the upwardly curved post 64 and the positioning post 86, as best shown in FIGS. 1-2 and 4. In one embodiment, the positioning mechanism 88 comprises a pin and aperture arrangement wherein one of the upwardly curved post 64 and positioning post 86 have a single aperture and the other has multiple apertures with a pin being sized and configured to fit through corresponding apertures (and then secured in place) to fix the position of the rear seat support post 70. As well known in the art, instead of utilizing a pin, this type of positioning mechanism 88 can utilize a bolt, screw or other elongated member that is sized to fit through correspondingly positioned apertures. Alternatively, the positioning mechanism 88 can comprise a wide variety of other devices that are commonly utilized to secure one tubular member to another tubular member. Any such positioning mechanism 88 must be selected to securely connect the positioning post 86 to the upwardly curved post 64.

As best shown in FIGS. 1-2 and 5-6, the handlebars 24 are disposed substantially rearward so they can be easily reached and gripped by the rider when he or she is sitting at the seating area 62 of the support fabric 56. In the preferred configuration, the handlebars 24 are pivotally adjustable where they connect to the forward end 18 of the frame 14 so the rider may pivot up or down depending on what is more comfortable to him or her. The configuration and operation of mechanisms to pivot and secure the handlebars 24 to the forward end 18 of the frame 14 are well known in the art. The rear seat support post 70 should be sized and configured so the “arms” of the U-shaped configuration, which form the midsection 76 that terminate in the ends 72/74, should be sufficiently wide to accommodate width of the torso of the likely riders that will utilize bicycle 10 of the present invention. Preferably, the width is sufficient for the rider to fit in the U-shape formed by the rear seat support post 70 but not so wide that it does not provide any support for the rider or harm the aesthetics of the bicycle 10. The various components of bicycle 10, such as the frame 14, front wheel assembly 22, handlebars 24, rear wheel assembly 26 and the pedal crank mechanism 28 are preferably made out of the same or similar materials which such components are made out of for conventional bicycles, including aluminum, steel, rubber, composites and the like. As with conventionally configured bicycles, the bicycle 10 of the present invention can also incorporate some non-traditional materials, such as carbon fiber and the like.

In one embodiment, the upper end 66 of the upwardly curved post 64 (or the positioning post 86 thereof) can be closed. As set forth above and shown in the drawings, however, in the preferred embodiment the upper end 66 of the upwardly curved post 64 (or the positioning post 86 thereof) has an opening 68 that can be utilized to support accessory items on bicycle 10. The bicycle 10 can be provided with a cap or cap-like member to close the opening 68 when the accessory items are not utilized to prevent rain, dirt or other materials from getting inside the tubular positioning post 86 and upwardly curved post 64. In the embodiment shown in FIGS. 8 and 9, the accessory item is an umbrella 90 that is supported above the rider when he or she is sitting in the seating area 62 formed by the support fabric 56 of the hammock-style seat 12. The umbrella 90 is supported above the hammock-style seat 12 by an accessory post 92 having a lower end 94 that is received into the connecting post 86 of the upwardly curved post 64 through the opening 68 at the upper end 66 thereof so as to place the upper end 96 of the accessory post 92 generally directly above the positioning post 86, as shown in FIG. 8. In the embodiment shown in FIGS. 8 and 9, the proximal end 98 of the umbrella 90 is attached to the upper end 96 of accessory post 92 so as to dispose the distal end 100 of the umbrella 90 generally forward toward, above or even beyond the forward end 18 of the frame 14. As best shown in FIG. 9, the umbrella 90 is generally triangular shaped, with the proximal end 98 thereof generally above the base end 60 of the support fabric 56 and the distal end 100 thereof generally above the apex end 58 of the support fabric 56, such that the umbrella 90 is generally in corresponding shape to the support fabric 56 of the hammock-style seat 12. In the preferred embodiment, however, the edges 102 of the umbrella 90 are stiffened (either with a stiffening rod or other member or by making the entire umbrella 90 stiff) so that the umbrella 90 maintains the desired shape (i.e., triangular), as best shown in FIG. 9 to provide cover for the rider when he or she is sitting in the seating area 62 defined by the support fabric 56. Preferably, the umbrella 90 is sized and configured to at least substantially protect the rider from rain, sun or other weather conditions, the type and extent of which may depend on where bicycle 10 is to be utilized, when he or she is riding bicycle 10. The umbrella 90 and accessory post 92 can be made out of materials which are commonly utilized for umbrellas and the posts that support those umbrellas.

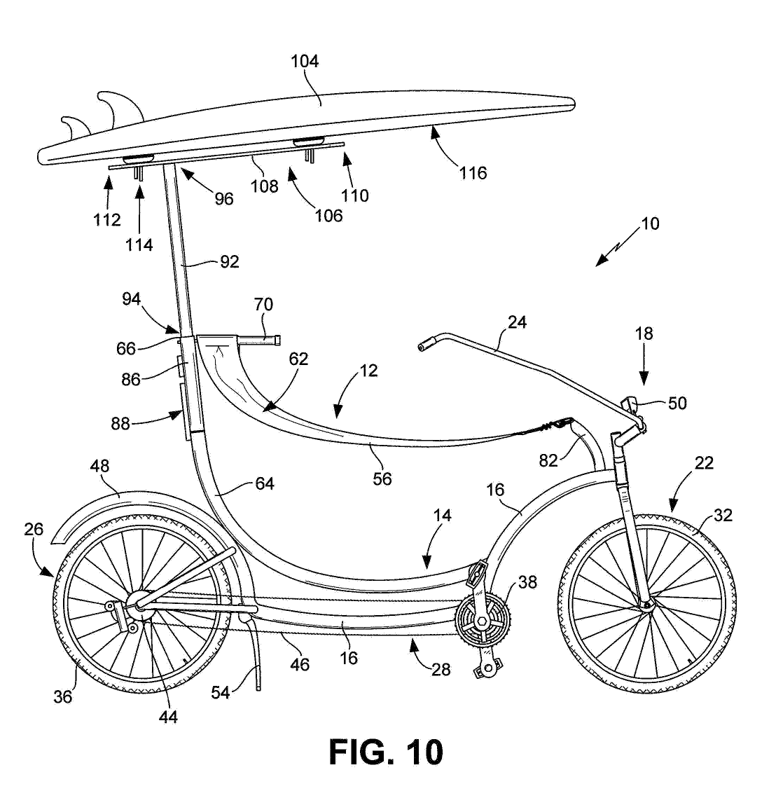

In the embodiment shown in FIG. 10, the accessory item is a surfboard 104 that is carried by the bicycle 10 so it can be utilized by the rider, typically, at the destination where he or she is riding (i.e., a beach). Alternatively, the accessory item could be a skateboard or other board or board-like item. The surfboard 104 is supported above the rider when he or she is sitting in the seating area 62 by a board support apparatus 106 that is attached to accessory post 92, as shown in FIG. 10. In the embodiment shown in the figures, the board support apparatus 106 comprises an elongated board member 108 having a first end 110 and a second end 112. The board member 108 is supported at the upper end 96 of the accessory post 92 such that the first end 110 is generally disposed toward the forward end 18 of the frame 14 and the second end 112 is disposed generally above or behind the rearward end 20 of the frame 14. The board support apparatus 106 also comprises a securing mechanism 114 that is configured to securely engage the surfboard 104, or other accessory item, so as to hold it on the board member 108 until the rider or other user desires to remove the accessory item (e.g., surfboard 104) from bicycle 10 for use thereof or to use the bicycle 10 without the accessory item. In the embodiment shown in FIG. 10, the securing mechanism 114 comprises one or more (two are shown) strong suction cups that are of the type which have a handle component that is moved to strongly engage the bottom surface 116 of the surfboard 104 and secure the surfboard 104 to the board support apparatus 106. Alternatively, the securing mechanism 114 can comprise one or more ropes, cables, bungee cords or other tie down devices. The securing mechanism 114 can also comprise clamps and the like. The board member 108 can be made out of a variety of different materials, including metal, plastic, wood, composites and the like, that are sufficiently strong and stiff to support the desired accessory item, such as the surfboard 104, and to cooperate with the securing mechanism 114 to secure the accessory item thereto.

In use, the rider will ride and operate the bicycle 10 of the present invention in substantially the same manner as he or she would ride and operate a conventional bicycle. Initially, the rider adjusts the height of the rear seat support post 70 by operating the positioning mechanism 88 to raise or lower positioning post 86 attached thereto (unless the height is fixed—namely no positioning post 86 or positioning mechanism 88) to place the seating area 62 at a level that is comfortable for him or her to sit while pedaling the bicycle 10. Once in position, the rider will grasp the handlebars 24 and then place his or her feet against the pedals 42 and utilize his or her legs to operate the pedal crank mechanism 28 to propel the bicycle 10 in a generally forward direction and he or she will steer the bicycle 10 using handle bars 24, in the same manner as conventional bicycles. If the user desires to utilize umbrella 90 for rain and/or sun protection or the board support apparatus 106 to carry a surfboard 104 or other board item, he or she will remove any cap member covering opening 68 and insert the lower end 94 of the accessory post 92 through the opening 68 and secure it to the upwardly curved post 64 (or positioning post 86 if utilized). Typically, the accessory post 92 will be secured in place using a pin or pin-like device. If the umbrella 90 is to be utilized, then the proximal end 98 thereof is attached to the upper end 96 of the accessory post 92 so as to extend the distal end 100 of the umbrella 90 over the rider when he or she is in the hammock-style seat 12. If a board item, such as surfboard 104, is to be carried by the bicycle 10, the board support apparatus 106 will be utilized. The board member 108 is attached (if not integral thereto) to the upper end 96 of the accessory post 92, the board item 104 is placed on top of the board member 108 and the securing mechanism 114 is operated to secure board item 104 to the board member 108. When the rider reaches his or her destination, he or she will operate the securing mechanism 114 in the reverse manner to remove the board item 104 from the board support apparatus 106. Typically, the board support apparatus 106 will remain on bicycle 10 so as to be ready for reuse to carry the same or another board item 104.

While there are shown and described herein one or more specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A bicycle, comprising:
a frame having a plurality of frame members defining a forward end and a rearward end of said frame, said plurality of frame members comprising an upwardly disposed post having an upper end thereof at or near said rearward end of said frame;
a front wheel assembly at said forward end of said frame;
a rear wheel assembly at said rearward end of said frame;
handlebars at said forward end of said frame;
a pedal crank mechanism interconnecting said frame and said rear wheel assembly;
a rear seat support post attached to or integral with said upwardly disposed post, said rear support post being generally U-shaped with a first end, a second end and a midsection disposed therebetween, said midsection of said rear support post attached to or integral with said upwardly disposed post at or near said upper end thereof; and
a hammock-style seat having a generally triangularly shaped support fabric with a base end connected to said rear seat support post and an apex end connected to said frame at or near said forward end thereof, said base end of said support fabric supported by said midsection of said rear seat support post substantially between said first end and said second end of said rear seat support post so as to form a seating area in said hammock-style seat.

2. The bicycle of claim 1 further comprising a front seat support post attached to one of said plurality of frame members at or near said forward end of said frame, said apex end of said support fabric attached to said front seat support so as to connect said apex end to said one of said frame members.

3. The bicycle of claim 2, wherein said apex end of said support fabric is removably attached to said front seat support post.

4. The bicycle of claim 3 further comprising a connecting mechanism interconnecting said apex end of said support fabric and said front seat support post.

5. The bicycle of claim 1, wherein each of said first end and said second end of said rear seat support post are disposed toward said forward end of said frame.

6. The bicycle of claim 5, wherein said rear seat support post is substantially horizontally disposed.

7. The bicycle of claim 6, wherein said support fabric comprises one or more tubular sections at said base end thereof, said rear seat support post received in each of said tubular sections so as to dispose each of said tubular sections at said midsection of said rear seat support post.

8. The bicycle of claim 1, wherein said support fabric comprises one or more tubular sections at said base end thereof, said rear seat support post received in each of said tubular sections so as to dispose each of said tubular sections at said midsection of said rear seat support post.

9. The bicycle of claim 1 further comprising a positioning post attached to said rear seat support post and a positioning means interconnecting said positioning post and said upper end of said upwardly disposed post for selectively positioning said rear seat support post and said base end of said support fabric relative to said upwardly disposed post.

10. The bicycle of claim 1, wherein said upper end of said upwardly disposed post has an opening sized and configured to receive a lower end of an accessory post.

11. The bicycle of claim 10 further wherein said accessory post has an upper end attached to or integral with an umbrella, said umbrella being sized and configured to be disposed generally above said seating area of said hammock-style seat.

12. The bicycle of claim 10 further wherein said accessory post has an upper end attached to or integral with a board support apparatus, said board support apparatus having a board member disposed generally above said hammock-style seat and a securing means for securing a board item to said board member.

13. A bicycle, comprising:
a frame having a plurality of frame members defining a forward end and a rearward end of said frame, said plurality of frame members comprising an upwardly curved post having an upper end thereof at or near said rearward end of said frame;
a front wheel assembly at said forward end of said frame;
a rear wheel assembly at said rearward end of said frame;
handlebars at said forward end of said frame;
a pedal crank mechanism interconnecting said frame and said rear wheel assembly;
a rear seat support post attached to or integral with said upwardly disposed end of said upwardly curved post, said rear support post being generally U-shaped with a first end, a second end and a midsection disposed therebetween, each of said first end and said second end of said rear seat support post being disposed toward said forward end of said frame; and
a hammock-style seat having a generally triangularly shaped support fabric with a base end connected to said rear seat support and an apex end connected to said frame at or near said forward end thereof, said base end of said support fabric supported by said midsection of said rear seat support substantially between said first end and said second end of said rear seat support so as to form a seating area in said hammock-style seat.

14. The bicycle of claim 13 further comprising a front seat support post attached to one of said plurality of frame members at or near said forward end of said frame, said apex end of said support fabric removably attached to said front seat support so as to connect said apex end to said one of said frame members.

15. The bicycle of claim 14 further comprising a connecting mechanism interconnecting said apex end of said support fabric and said front seat support post.

16. The bicycle of claim 13, wherein said rear seat support post is substantially horizontally disposed.

17. The bicycle of claim 16, wherein said support fabric comprises one or more tubular sections at said base end thereof, said rear seat support post received in each of said tubular sections so as to dispose each of said tubular sections at said midsection of said rear seat support post.

18. The bicycle of claim 13 further comprising a positioning post attached to said rear seat support post and a positioning means interconnecting said positioning post and said upper end of said upwardly disposed post for selectively positioning said rear seat support post and said base end of said support fabric relative to said upwardly disposed post.

19. The bicycle of claim 1, wherein said upper end of said upwardly disposed post has an opening sized and configured to receive a lower end of an accessory post, said accessory post having an upper end attached to or integral with one of an umbrella and a board support apparatus so as to dispose said umbrella or said board support apparatus generally above said seating area of said hammock-style seat.

20. A bicycle, comprising:
a frame having a plurality of frame members defining a forward end and a rearward end of said frame, said plurality of frame members comprising an upwardly curved post having an upper end thereof at or near said rearward end of said frame;
a front wheel assembly at said forward end of said frame;
a rear wheel assembly at said rearward end of said frame;
handlebars at said forward end of said frame;
a pedal crank mechanism interconnecting said frame and said rear wheel assembly;
a rear seat support post attached to or integral with said upwardly disposed end of said upwardly curved post, said rear support post being generally U-shaped with a first end, a second end and a midsection disposed therebetween, said rear seat support post being substantially horizontally disposed with each of said first end and said second end of said rear seat support post being disposed toward said forward end of said frame;
a front seat support post attached to one of said plurality of frame members at or near said forward end of said frame; and
a hammock-style seat having a generally triangularly shaped support fabric with a base end connected to said rear seat support and an apex end removably attached to said front seat support post so as to extend said support fabric substantially between said forward end of said frame and said rearward end of said frame, said base end of said support fabric supported by said midsection of said rear seat support substantially between said first end and said second end of said rear seat support so as to form a seating area in said hammock-style seat.
